(19) United States
(12) Patent Application Publication
(10) Pub. No.: US 2017/0072752 A1
(43) Pub. Date: Mar. 16, 2017

(54) AIR MAINTENANCE PUMP ASSEMBLY

(71) Applicant: The Goodyear Tire & Rubber Company, Akron, OH (US)

(72) Inventor: Cheng-Hsiung Lin, Hudson, OH (US)

(21) Appl. No.: 15/343,782

(22) Filed: Nov. 4, 2016

Related U.S. Application Data
(63) Continuation-in-part of application No. 14/519,176, filed on Oct. 21, 2014.

(51) Int. Cl. B60C 23/12; F04B 53/10; F04B 39/12; F04B 39/00; F04B 41/06; F04B 35/01

(52) U.S. Cl. CPC B60C 23/12; F04B 41/06; F04B 35/01; F04B 39/12; F04B 39/0005; F04B 53/10

(57) ABSTRACT

A pumping assembly keeps a pneumatic tire from becoming underinflated. The pumping assembly includes at least one pump attached to the tire rim, a cam fixed to the gravity mass for maintaining the cam in a fixed position relative to the gravity mass, and rollers for engaging the cam and producing the pumping action as the tire rim rotates and the gravity mass retards rotation of the cam.

### FIELD OF THE INVENTION

The present invention generally relates to automotive and other vehicles, and more specifically, to a pump assembly for automatically inflating a pneumatic tire mounted on a wheel.

### BACKGROUND OF THE INVENTION

Low tire pressure is a major cause of excessive fuel consumption, tire wear, and impaired steerability. A typical pneumatic tire will leak about 25 percent of its pressure per year due to rubber's inherent permeability. It is thus good practice to check/maintain tire pressure on a regular basis.

However, even checking tire pressure every few weeks may not prevent these adverse affects when a slow leak is present, and the leak may go undetected unless a careful record is maintained of how frequently the pressure in each tire has to be replenished. A fast leak or flat condition may rapidly cause damage to the tire and even render it unusable in a short period of time even though this condition may go unnoticed by an inexperienced driver until it is too late. It is thus desirable to have an efficient pumping mechanism that automatically replenishes the tire pressure when it is lower than its optimal amount.

### SUMMARY OF THE INVENTION

A pumping assembly in accordance with the present invention which keeps a pneumatic tire from becoming underinflated is described. The pumping assembly includes at least one pump having a first and second chamber, wherein the chambers are in fluid communication with each other. Alternatively, two single chamber pumps may be used wherein their chambers are connected in series. The assembly further includes a cam connected to a gravity mass for retarding rotational motion of the cam, and a roller for engaging the cam and producing the pumping action as the tire rotates. The pumping assembly produces an amplification effect wherein the outlet pressure of one chamber becomes the inlet pressure of another chamber. Preferably, the outlet of the one chamber is separated from the inlet of another chamber by a check valve.

According to another aspect of the pumping assembly, the assembly further includes an outlet for directing pressurized air into a valve stem of the pneumatic tire.

According to still another aspect of the pumping assembly, a filter is disposed adjacent the inlet to the air system or adjacent the valve stem.

According to still another aspect of the pumping assembly, an adjustable pressure control valve determines the pressure of air entering a tire cavity of the pneumatic tire.

According to still another aspect of the pumping assembly, four pumps are mounted at 90 degree increments about the tire rim, wherein each of the four pumps is connected in series with the other three pumps such that the pumping assembly produces an amplification effect wherein the outlet pressure of one pump becomes the inlet pressure of another pump. Each of the four pumps preferably has two chambers and a single predetermined compression ratio for each chamber.

### BRIEF DESCRIPTION OF THE DRAWINGS

The present invention will be described by way of example and with reference to the accompanying drawings, in which:

FIG. 1 is a schematic shows of an example assembly in accordance with the present invention.

FIG. 2 schematically shows part of another example assembly in accordance with the present invention.

FIG. 3 schematically shows part of still another example assembly in accordance with the present invention.

FIG. 4 schematically shows yet another example assembly in accordance with the present invention.

FIG. 5 schematically shows the operation of the example assembly of FIG. 4.

FIG. 6 schematically shows an example cam for use with the example assembly of FIG. 4.

FIG. 7 schematically shows operation of part of the assembly FIG. 4.

FIG. 8 schematically demonstrates the functioning of an example assembly in accordance with the present invention.

FIG. 9 illustrates a pumping assembly mounted to a mounting plate.

FIG. 10 illustrates the assembly of FIG. 9 attached to a wheel.

FIG. 11 illustrates a schematic of a double chamber pump arranged in series.

FIG. 12 illustrates the connections of the mechanical components of FIG. 11.

FIG. 13 illustrates the connection of the pumps of FIG. 11.

FIG. 14A is a second embodiment of a pumping assembly of the present invention.

FIG. 14B is an optional cover plate for the pumping assembly of FIG. 14A.

FIG. 15 is a perspective view of the pumping assembly of FIG. 14A.

FIG. 16 is a cross-sectional view of the pumping assembly of FIG. 14A.

FIGS. 17A, B and C are side, top and perspective views of the cam of FIG. 14A.

FIGS. 18A and 18B are respective side and top views of the pump connector of FIG. 14A

FIG. 19 is a side view of a pump suitable for use with the invention.

FIG. 20 is a perspective view of the roller.

### DETAILED DESCRIPTION OF EXAMPLES OF THE PRESENT INVENTION

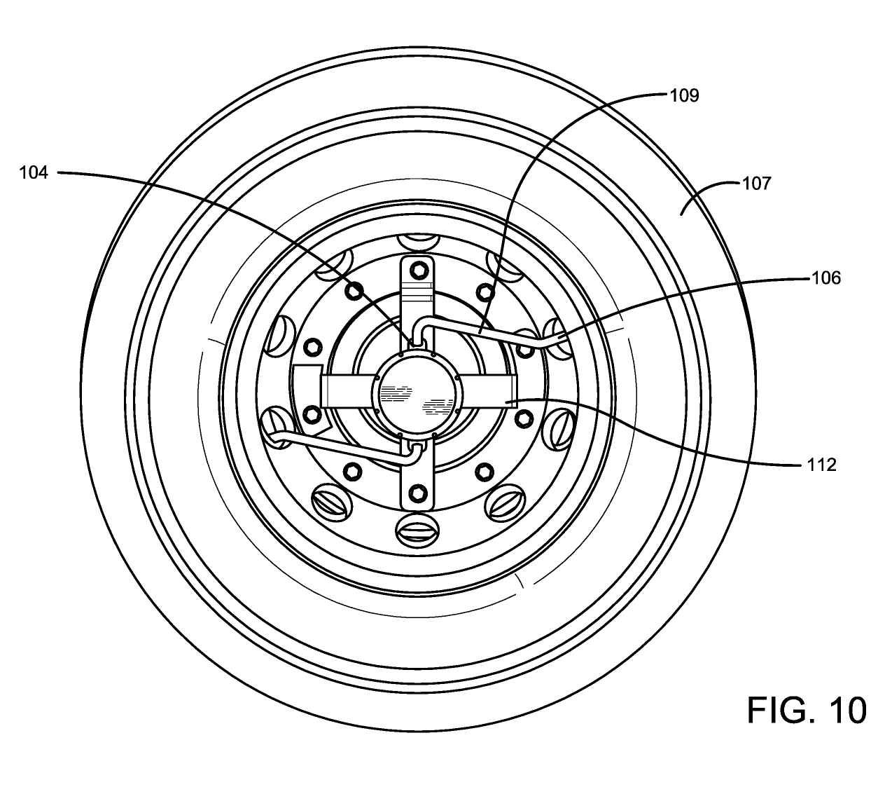

An assembly 100 in accordance with the present invention defines a multi-chamber pumping assembly suitable for mounting to a wheel of a vehicle, as shown in FIG. 10. The assembly 100 may provide a low profile and effective tire air maintenance system which may be externally mounted without modification to the standard wheel. Further, the assembly introduces no issue when mounting a conventional tire to the wheel.

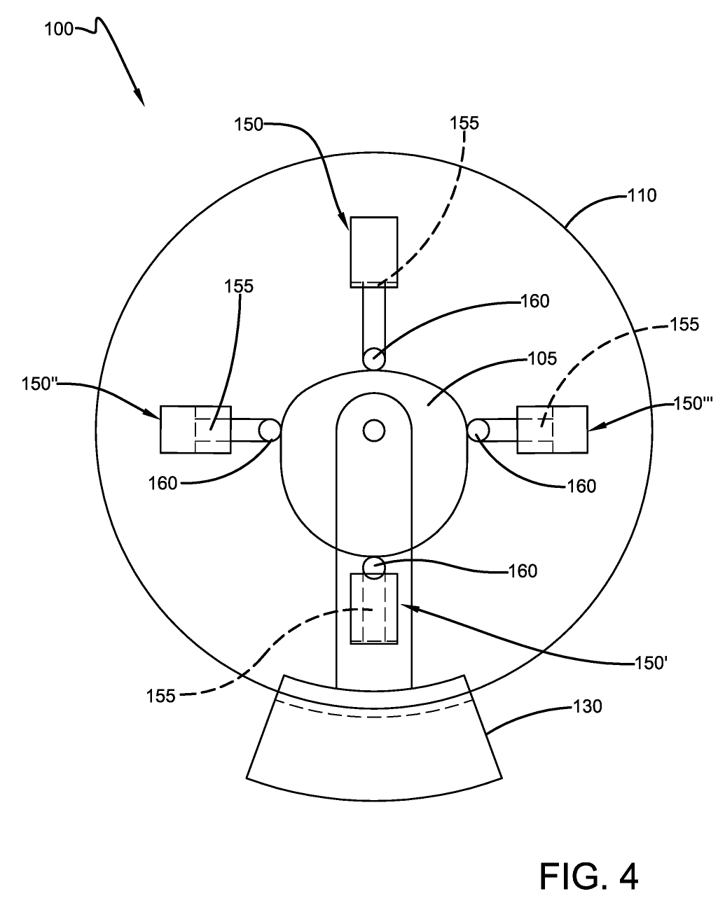

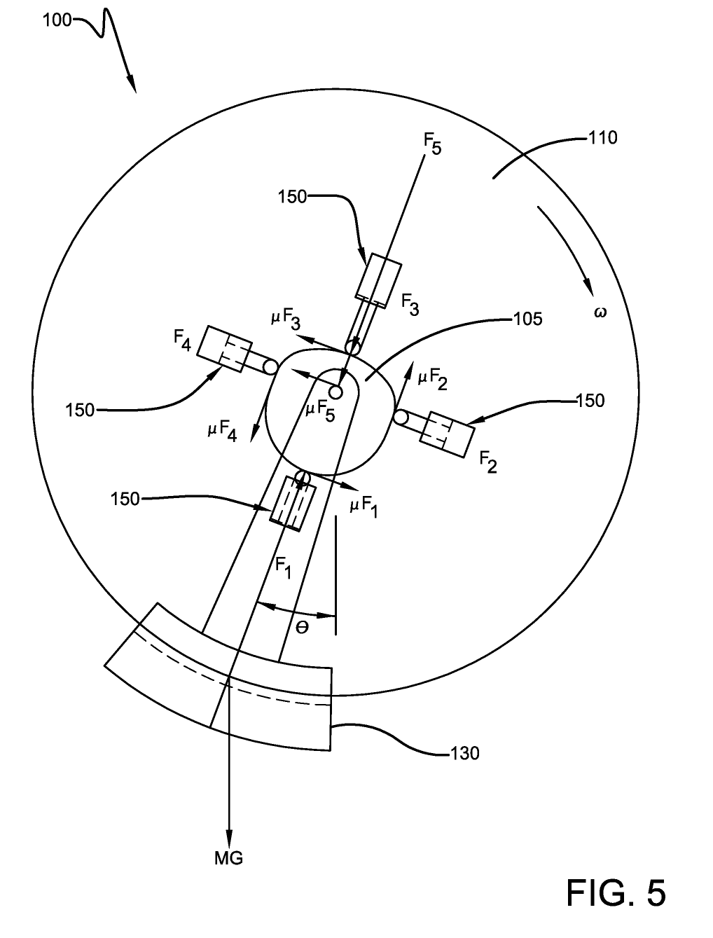

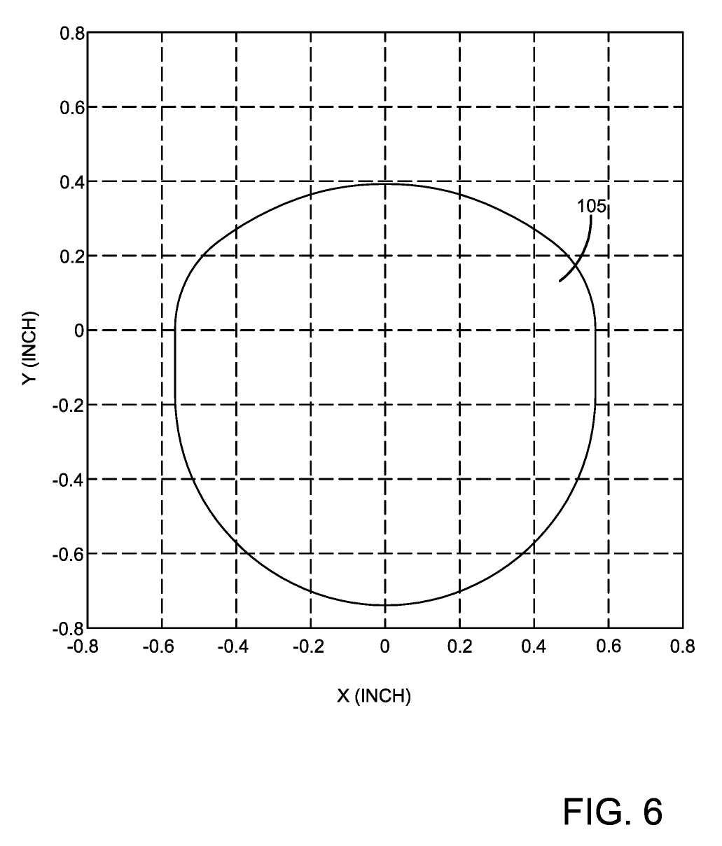

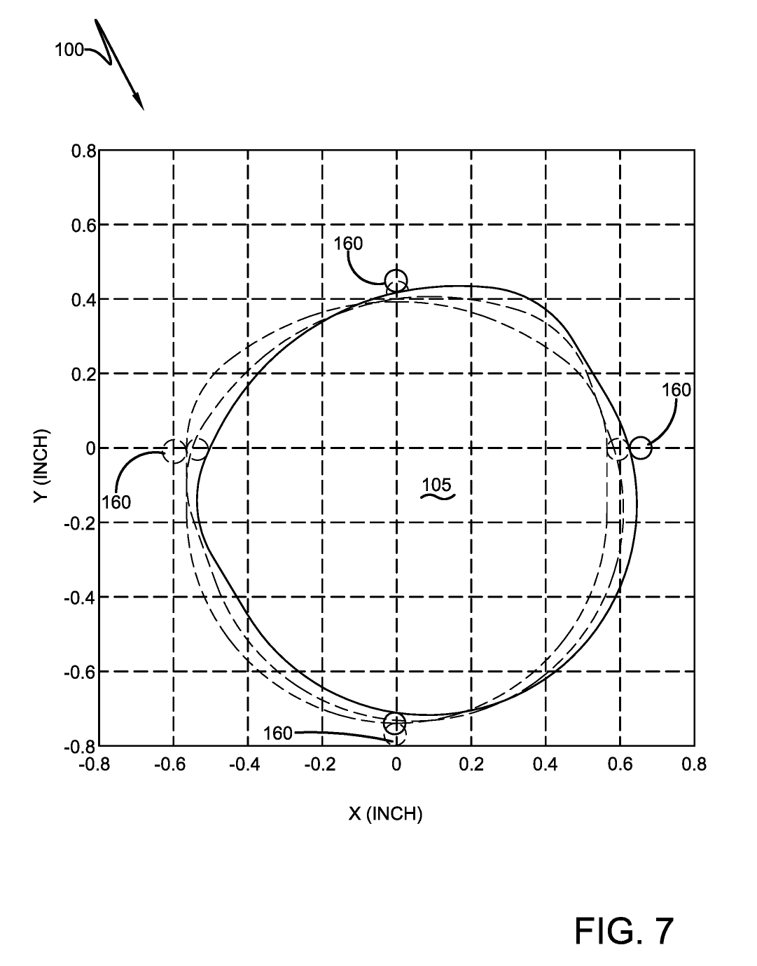

As shown in FIG. 4, the pump assembly 100 includes an unbalanced mass 130 and a cam 105, which may be used to drive the pumps of the assembly 100. The unbalanced mass 130 is connected to the cam 105 so that the unbalanced mass 130 retards motion of the cam when the assembly 100 is rotated. The unbalanced mass 130 and cam 105 may be integrally formed as a single unit. The cam is mounted to the assembly with extra low friction bearings to ensure free rotation (low resistance) for the cam 105 and mass 130. As shown in FIG. 5, the unbalanced mass 130 may be maintained at a vertical position due to gravity and low bearing friction, regardless of any rotational position of the wheel. The cam 105 is the actuating mechanism of the pistons 155, as described in more detail, below. As the wheel rotates, the heavy mass 130 is maintained in a fixed position relative to the ground due to torque balance between the mass 130 and pump generated resistance (e.g., friction of pump rollers 160 and bearings). The assembly 100 may pump at lower efficiency as long as the unbalanced mass rotates at a speed different than the tire/wheel rotation.

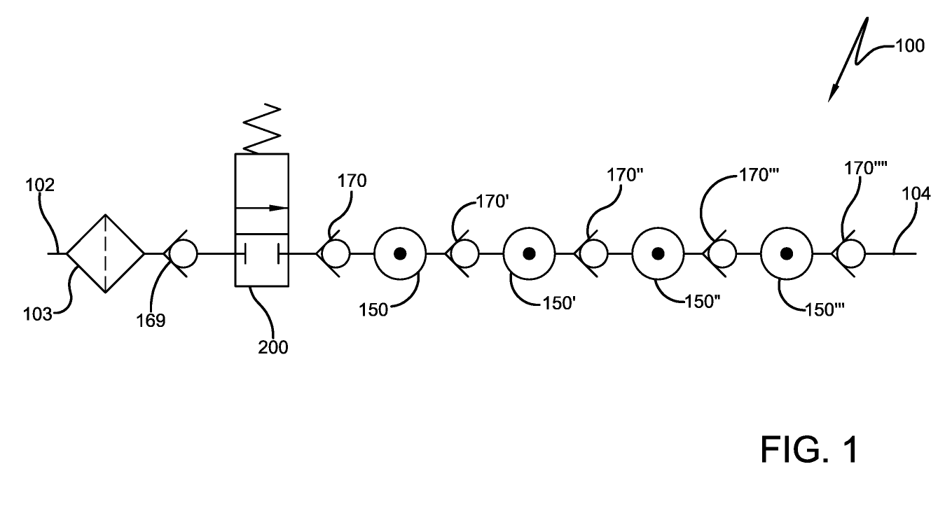

The assembly further includes at least two single chamber pumps 150, 150′. Each pump has a piston 155 having a first mounted in a respective chamber and a second end having a roller 160 mounted thereon. The pumps 150,150′ are preferably arranged opposite each other, and are each arranged so that the roller 160 is positioned for engagement with the cam 105. As shown in FIGS. 1 and 4, each pump is connected in series, so that the outlet of pump 150 is directed into the inlet of the pump 150′, and the outlet of the 150′ pump is directed into the tire cavity. A check valve 170 is positioned between the chambers 150,150′.

FIG. 4 illustrates an exemplary arrangement of four single chamber pumps. In this arrangement, it is preferred that the pump chambers are connected together in series in the following order as shown in FIG. 1: 150, 150′, 150″, 150′″. Thus the outlet of the 150 pump is directed into the inlet of the 150′ pump, the outlet of the 150′ pump is directed into the inlet of the 150″ pump, the outlet of the 150″ pump is directed into the inlet of the 150′″ pump, and the outlet of the 150′″ pump is directed into the tire cavity. As shown in FIG. 1, check valves 170,170′, 170″, 170′″, are positioned between the chambers.

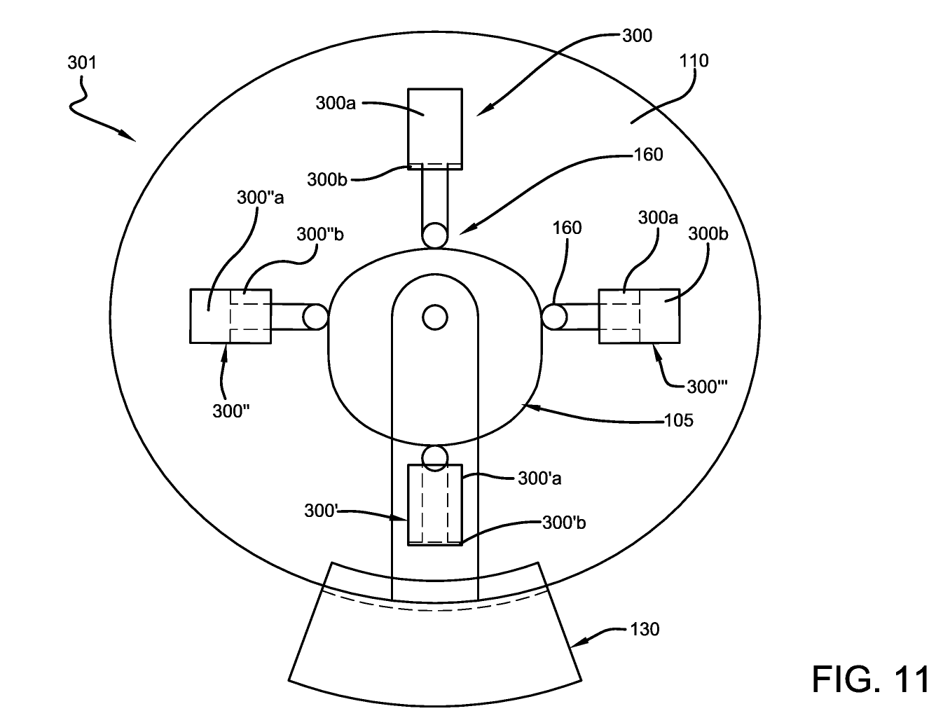

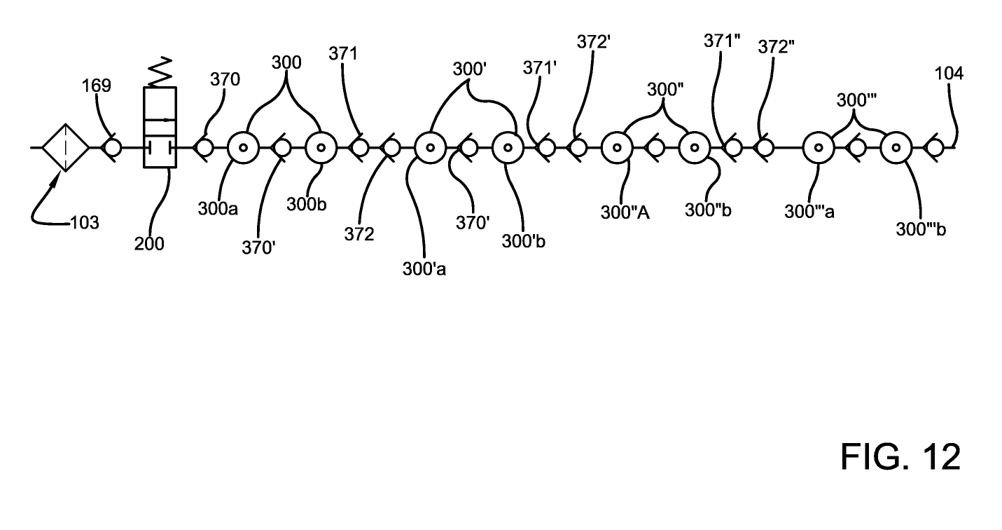

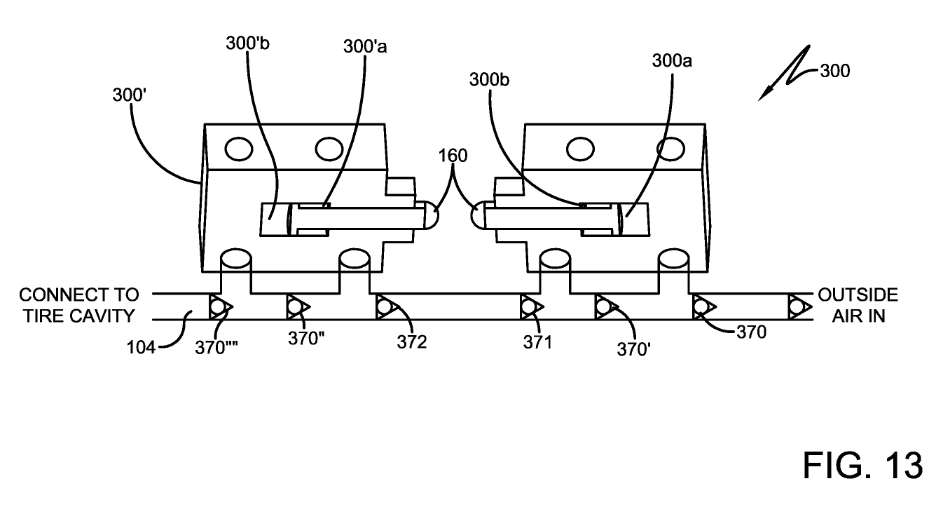

The pump used for the invention may comprise at least one double chamber piston pump. The chambers 300a and 300b of a double piston pump 300 are connected in series as shown in FIGS. 12 and 13. FIG. 11 illustrates an exemplary arrangement 301 of four double chamber pumps 300,300′,300″,300′″, each pump having chambers a and b. In this arrangement, it is preferred that the pump chambers are connected together in series in the following order as shown in FIG. 1: 300a, 300b, 300a′, 300b′, 300a″, 300b″, 300a′″,300b′″. Thus the outlet of the 300 pump is directed into the inlet of the 300′ pump, the outlet of the 300′ pump is directed into the inlet of the 300″ pump, the outlet of the 300″ pump is directed into the inlet of the 300′″ pump, and the outlet of the 300′″ pump is directed into the tire cavity. As shown in FIGS. 1 and 13, check valves 370,370′, 370″, 370′″, are positioned between the chambers and between each pump. Preferably, there are two check valves 371,372 positioned between pumps.

Alternatively, the pumps may be connected together in the following sequence: 300a, 300b, 300a′, 300b′,300a′″,300b′″, 300a′, 300b″.

An optional reservoir chamber may be added to the assembly 100 for absorbing rapid pressure losses to the tire cavity. Preferably, the pump assembly is mounted in a housing that has an interior cavity forming a reservoir.

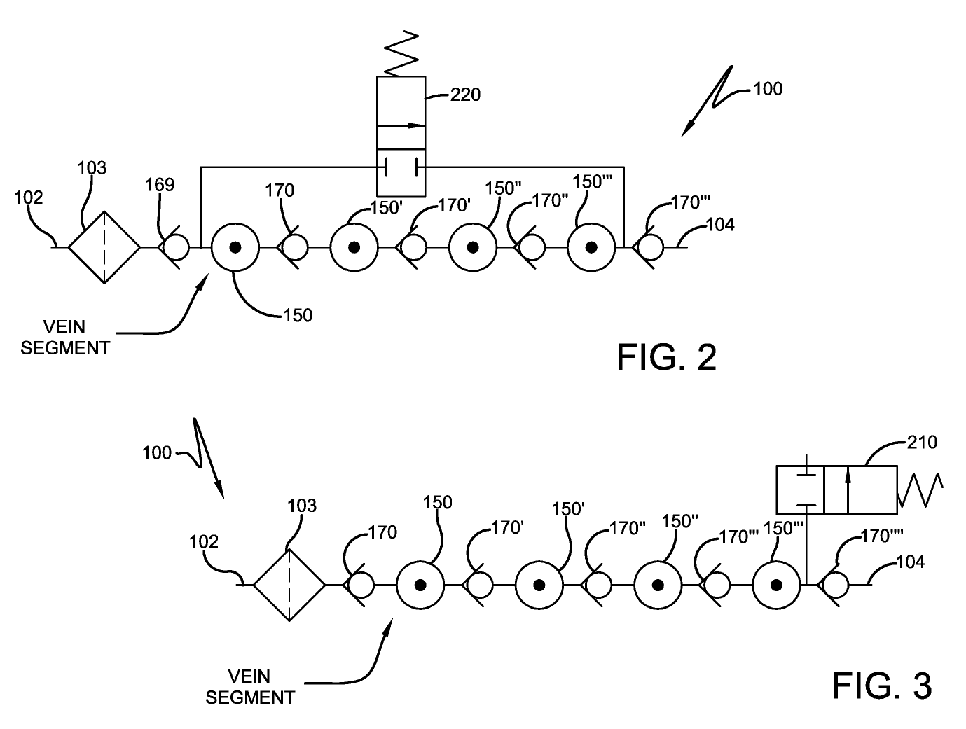

Mechanical or electronic control valve/pressure sensing may be used as a pressure/flow control unit. As shown in FIG. 1, the assembly may include an inlet control valve 200 that opens when the tire cavity pressure is lower than the desired pressure. FIG. 3 illustrates that the tire cavity pressure may be controlled at the outlet to the assembly 100 via control valve 210. FIG. 2 illustrates that the system may operate in a bypass mode, and allow air to flow to the tire cavity when needed. The air inlet may include a filter 103 to prevent foreign items from being inlet to the pump system and blocking the pump system.

The outlet 104 from the pump system 100 may directly connect to a modified tire valve stem 106 via a hose 109, as shown in FIG. 10. This modified valve stem may retain its normal function (e.g., filling the tire cavity by air pump, deflating the tire for tire service, tire pressure measurement, etc.). The filter 103 may alternatively be placed at the air outlet to the tire cavity. As with the conventional vein system, the assembly 100 may be independent of the direction of rotation of the tire. An adjustable pressure control valve may also easily fit into this assembly.

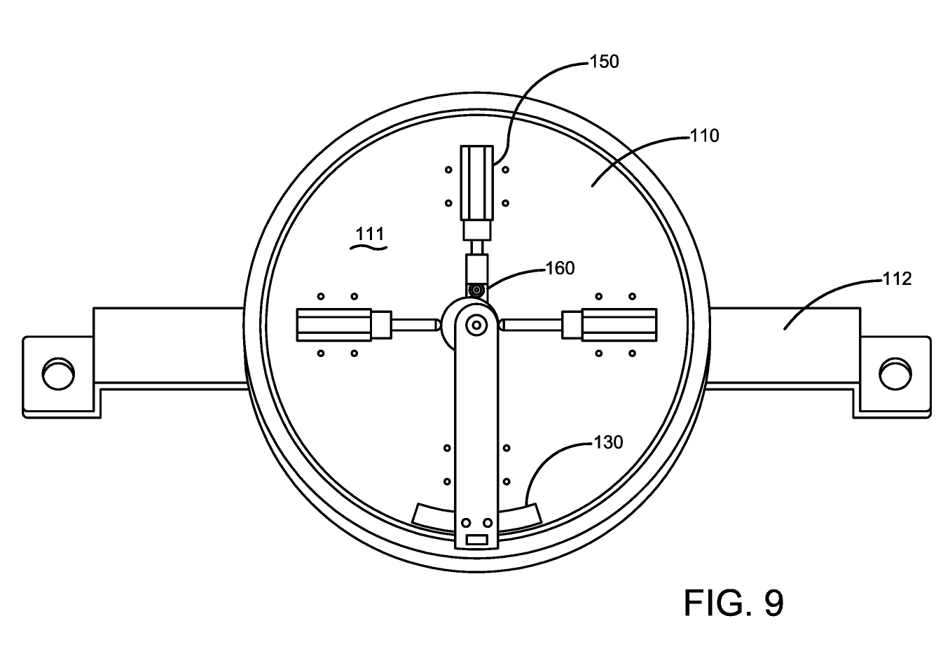

As shown in FIG. 9, the pumping assembly 100 may be mounted to a mounting plate 110 that is secured to the bolt pattern of a wheel hub via support brackets 112. The assembly 100 does not interfere with tire mount/dismount and provides a simple installation for the assembly, such as after-market addition of the assembly to a vehicle. The assembly 100 may function bi-directionally, regardless of the direction of rotation of the wheel/tire. Further, the installation direction will have no effect on pumping performance

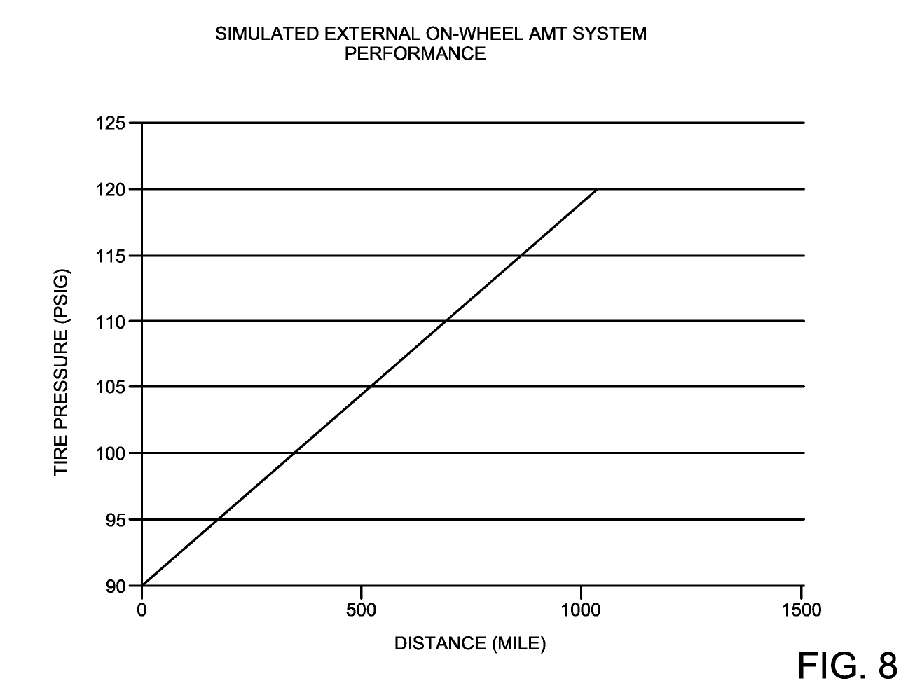

The assembly 100 provides a relatively high compression ratio and a relatively high pumping capacity due to the amplification effect of the serially connected chambers. The pumping rate is linear through most of pressure range of the assembly, as shown in FIG. 8. Due to the amplification effect of the assembly 100, compression may be defined as: R=(r)ⁿ, where R is the assembly compression ratio, r is the single chamber compression ratio, and n is the total number of chambers in the assembly. Therefore, a high compression ratio for each single chamber may not be required. As the example assemblies of FIGS. 1-3 show, the assembly 100 may thus produce a staged air pressure amplifier effect that may be used to overcome low pumping force created by gravity. Each double chamber pump may represent two segments of vein system (i.e., each chamber is a segment) that generates small pressure differential (10 to 15 psi) for the next pump unit (e.g., staged amplifier). This amplifier assembly 100 may generate 150 psi air from standard 90 psi air source.

FIG. 5 defines force distribution of the assembly 100. F1, F2, F3, and F4 may be generated by the chamber pressures of the pumps 150. If the mass m or 130 does not rotate with the tire/wheel 107 (e.g., Θ is a constant because lack of torque to move mass 130), ω=0 and F5=mg(cos Θ). Rmg(sin Θ)=rbμF5+r1μF1+r2μF2+r3μF3+r4μF4 to obtain Θ where −n/2<Θ<n/2. If m rotates coincidentally with the tire/wheel 107, Θ is not constant and F5=mR\acute{ω} 2, rbμF5+r1μF1+r2μF2+r3μF3+r4μF4>Rmg(sin Θ) for any Θ, and, therefore, rbμF5+r1μF1+r2μF2+r3μF3+r4μF4>Rmg.

Based on one example of a miniature piston pump with double chambers, an active pump volume may equal 271.5 mm3. Such an assembly 100 may have a pump rate of 2.92 psi per 100 miles, regardless of load. Wheel rotation direction may not affect pumping performance. A very small torque may be incurred at the pump rollers 160. FIG. 8 illustrates a simulated tire pressure shown versus distance traveled.

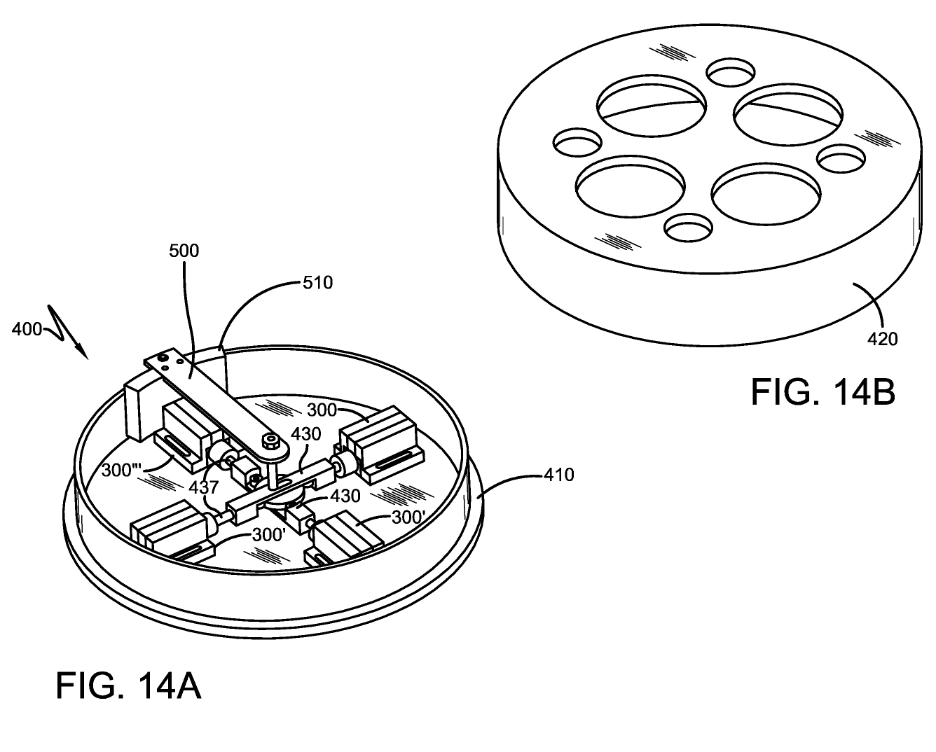

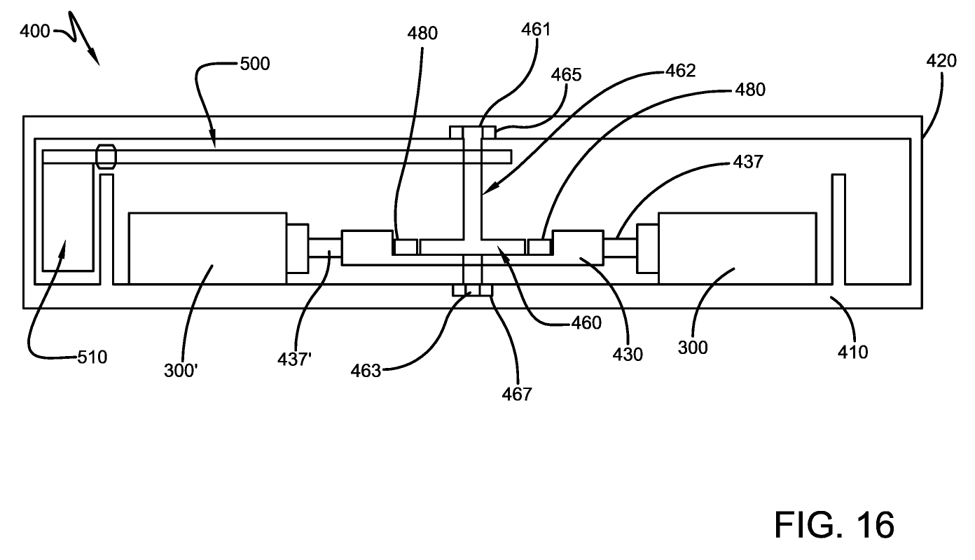

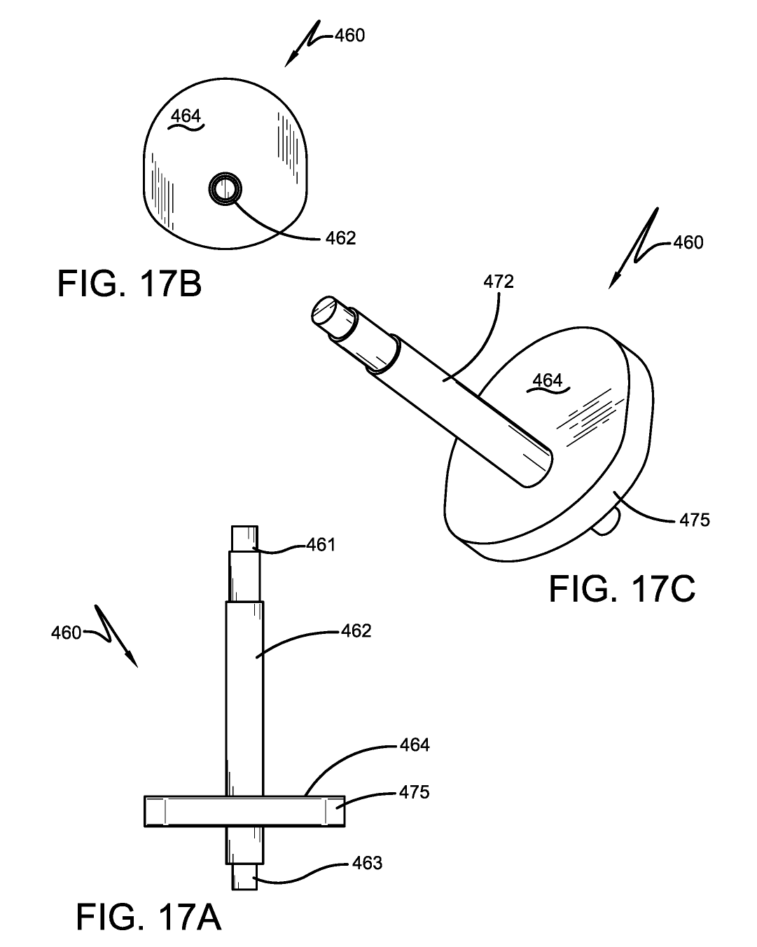

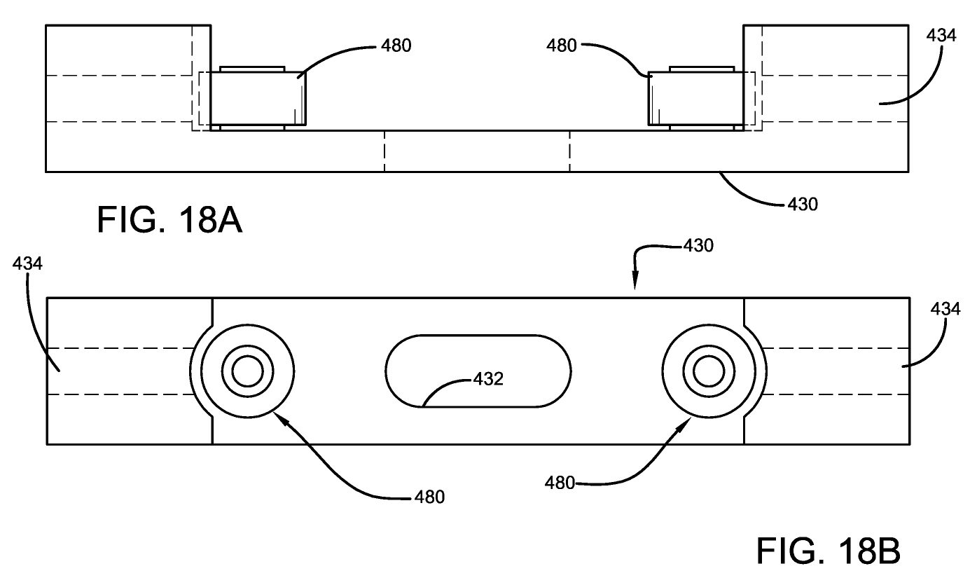

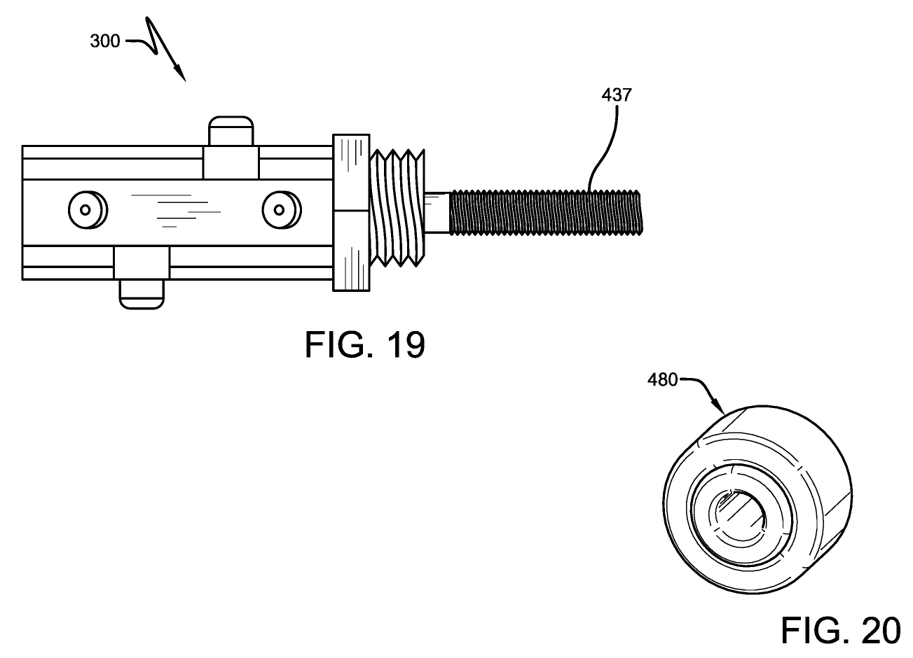

FIGS. 14-20 illustrate an additional embodiment of a pumping assembly 400 of the present invention. The system includes a mounting plate 410, and at least one pump 300 mounted thereon. The pump may be a single chamber pump and/or a double chamber pump. The system further includes a mass arm 500 affixed to a cam shaft 462 of cam 460. The cam shaft 462 is rotatably mounted in the housing formed by the assembly of the mounting plate 410 and cover 420. The opposed ends 461,463 of the cam shaft 462 are received in bearings 465,467. The arm 500 is either integrally formed with or joined to a weighted mass 510, which retards motion of the cam during rotation of the assembly in operation. The assembly is mounted to the bolts of a hub of a wheel as shown in FIG. 10. During operation, the weight of the mass is oriented into a vertical or near vertical position, resulting in the cam being maintained in a stationary position relative to the pumps 300. Rollers 480 engage the cam surface, and roll around the cam surface 475 during operation. The rollers are preferably roller bearings, as shown in FIG. 20. The rollers 480 are rotatably mounted to pump connector 430. The pump connector has opposed ends 431,433, which are affixed to the distal end of the pump piston 437. The distal end 437 is received and secured in the slot 434 of the pump connector. The pump connector has an elongated slot 432 which is mounted about the cam shaft 462 and oriented so that the rollers 480 engage the outer surface 475 of the cam.

If two pumps are used, it is preferable that they are oriented 180 degrees apart from one another. If only two pumps are used, only one pump connector is needed. If four pumps are used such as shown in FIG. 14a, then there are two pump connectors 430 utilized. The pump connectors are oriented 90 degrees with respect to each other.

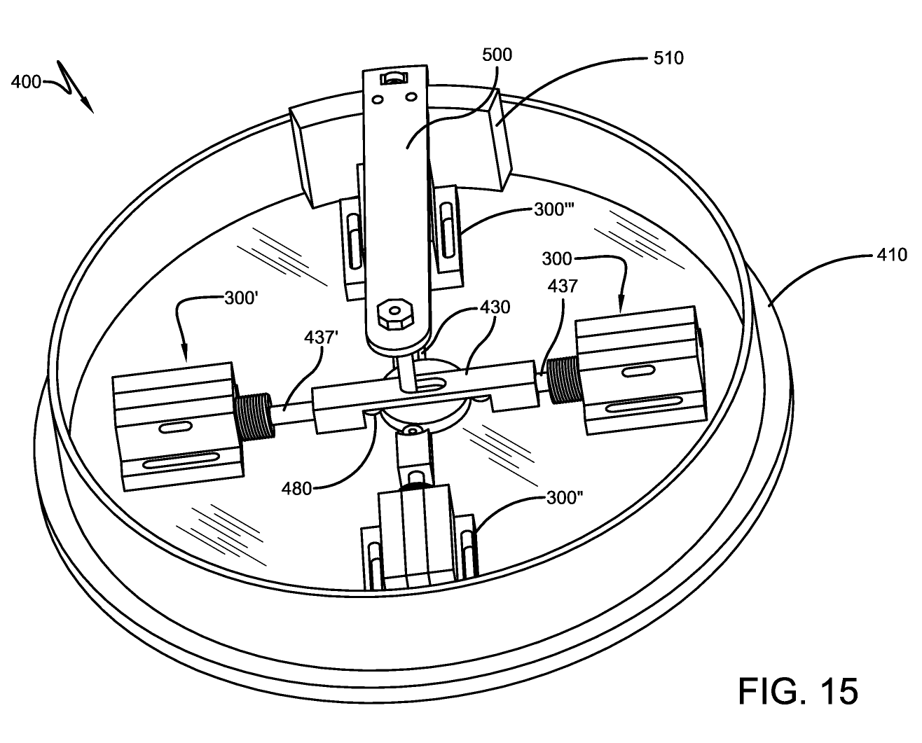

During operation, each roller 480 engages the cam 105, resulting in the sliding of the camshaft 462 in each slot 432 of the pump connector. The sliding of the pump connector causes the piston to actuate the pump, resulting in compression of the air. FIG. 15 illustrates that pump 300 has its piston fully retracted, while pump 300′ has its piston fully extended.

For clarity, the connections of the pumps and check valves are not shown in 14-16. FIGS. 12-13 illustrate schematically the connections of the pump chambers to each other and the placement of the check valves located therebetween. The first pump 300 in the series is in fluid communication with the outside air through a hole in the mounting plate. The inlet air may pass through a filter prior to entering the pumps. Preferably, there are at least two double chamber piston pumps connected in series as shown in FIG. 20. Preferably, the second double chamber pump 300′ is located 180 degrees across from the first double chamber pump 300. The first pump 300 is configured so that the first chamber 300a is in fluid communication with the second chamber 300b. A check valve 370 is preferably positioned between the chambers 300a,b in order to prevent backflow. The second chamber 300b of the first pump is in fluid communication with the first chamber 300a′ of the second pump 300′. A check valve 371 is positioned downstream of the second chamber 300b and an optional check valve 372 is positioned upstream of the first chamber 300a′. The first chamber 300a′ is in fluid communication with the second chamber 300b′ of the second pump 300′ and a check valve 370′ is preferably located therebetween. The outlet of the second chamber 300b′ is in fluid communication with the tire cavity 104. The pressurized air may be fed into the tire cavity via a hose 109 connected to the valve stem of a tire.

While a certain representative examples and details have been shown for the purpose of illustrating the present invention, it will be apparent to those skilled in the art that various changes and modifications may be made therein without departing from the spirit or scope of the present invention.

What is claimed:

1. A pumping assembly for use with a pneumatic tire mounted on a tire rim to keep the pneumatic tire from becoming underinflated, the pumping assembly comprising:
a mounting plate for securing to the tire rim;
a pump having two chambers, said pump being attached to the mounting plate, wherein the outlet of the first chamber is connected to the inlet of the second chamber;
a cam for producing a pumping action, said cam being rotatably mounted to the mounting plate;
a gravity mass fixed to the cam for maintaining the cam in a vertical position;
said pump having a roller for engaging the cam and producing the pumping action as the tire rim rotates.

2. The pumping assembly of claim 1 wherein the outlet of the pumping assembly is in fluid communication with a valve stem of a tire.

3. The pumping assembly of claim 3 wherein the outlet of the pumping assembly is in fluid communication with a valve stem of a tire.

4. The pumping assembly of claim 1 wherein the pumping assembly is mounted in a reservoir.

5. The pumping assembly as set forth in claim 1 further including an inlet control valve for controlling the air flow into the assembly.

6. The pumping assembly as set forth in claim 1 wherein the pumping assembly pumps pressurized air in either direction of rotation of the tire rim.

7. The pumping assembly as set forth in claim 1 wherein the outlet pressure of each pump becomes the inlet pressure of an adjacent pump so that the pumping assembly produces an amplification effect.

8. The pumping assembly as set forth in claim 1 further comprising a second pump having a first chamber and a second chamber, wherein the outlet of the first pump is fed into the inlet of the second pump, and wherein a first check valve is located between the first pump and the second pump.

9. The pumping assembly as set forth in claim 8 wherein a check valve is positioned at the outlet of each chamber.

10. The pumping assembly as set forth in claim 8 wherein there is a first check valve positioned at the outlet of the first pump, and a second check valve positioned at the inlet of the second pump.

11. A pumping assembly for use with a pneumatic tire mounted on a tire rim to keep the pneumatic tire from becoming underinflated, the pumping assembly comprising: a mounting plate for securing to the tire rim; at least two pumps attached to the mounting plate wherein an outlet of the first pump is connected to an inlet of the second pump; a cam for producing a pumping action, said cam being secured to the mounting plate; a gravity mass fixed to the cam retarding rotation of the cam as the tire rotates; and rollers for engaging the cam and producing the pumping action as the tire rim rotates.

12. The pumping assembly as set forth in claim 11 wherein the pump has two chambers, wherein the outlet of the first chamber is connected to the inlet of the second chamber.

13. The pumping assembly as set forth in claim 11 wherein a check valve is positioned between the outlet of the first chamber and the inlet of the second chamber.

14. A pumping assembly for use with a pneumatic tire mounted on a tire rim to keep the pneumatic tire from becoming underinflated, the pumping assembly comprising:
a mounting plate for securing to the tire rim;
a first and second pump mounted on said mounting plate wherein said first pump has a first chamber, and wherein said second pump has a first chamber, wherein the outlet of the first chamber of the first pump is connected to the inlet of first chamber of the second pump;
a cam for producing a pumping action, said cam being rotatably mounted to the mounting plate;
a gravity mass fixed to the cam for retarding rotation of the cam;
each of said pumps having a roller for engaging the cam and producing the pumping action as the tire rim rotates, wherein each of the rollers are mounted on a pump connector, wherein said first pump and the second pump each have a piston, wherein a distal end of each piston is secured to the pump connector.

15. The pumping assembly of claim 14 wherein the pump connector is slidably mounted to a cam shaft of the cam.

16. The pumping assembly of claim 15 wherein a check valve is located between the first chamber and the second chamber.

17. The pumping assembly of claim 14 wherein the first and second pump each have a second chamber, wherein the first chamber of the first pump is in fluid communication with the second chamber of the first pump, and the first chamber of the second pump is in fluid communication with the second chamber of the second pump.

18. The pumping assembly of claim 17 wherein there are two check valves located between the first pump outlet and the second pump inlet.

19. The pumping assembly of claim 17 wherein the first pump and the second pump are spaced 180 degrees apart from each other.

20. The pumping assembly of claim 17 further comprising and third and fourth pump.
